(19) United States
(12) Patent Application Publication
(10) Pub. No.: US 2009/0221202 A1
(43) Pub. Date: Sep. 3, 2009

(54) COMPOSITE MATERIALS CONTAINING HYDRAULIC BINDERS

(75) Inventors: Martin Moller, Aachen (DE); Oliver Weichold, Aachen (DE)

Correspondence Address: VIKSNINS HARRIS & PADYS PLLP, P.O. BOX 111098, ST. PAUL, MN, 55111-1098, US

(73) Assignee: Deutsches Wollforschungsinstitut an der RWTH Aachen e.V., Aachen (DE)

(21) Appl. No.: 12/093,074

(22) PCT Filed: Nov. 11, 2006
(86) PCT No.: PCT/EP2006/068307

§ 371 Date: Oct. 27, 2008

(30) Foreign Application Priority Data
Nov. 9, 2005 (DE) 10 2005 053 490.2

(51) Int. Cl. B32B 17/04; C04B 24/26; B32B 5/16; D02J 1/00

(52) U.S. Cl. 442/180; 524/2; 524/8; 524/5; 428/338; 264/103

(57) ABSTRACT

The invention relates to novel composite materials, which comprise at least one thermoplastic organic polymer matrix and at least one hydraulic binder distributed in the polymer matrix. The invention also relates to a process for the preparation of such composite materials and to the use of these composite materials in textile materials. The composite materials comprise at least one thermoplastic organic polymer matrix and at least one hydraulic binder distributed in the polymer matrix, where the thermoplastic polymer matrix consists predominantly, i.e. to at least 60% by weight, in particular to at least 70% by weight, preferentially to at least 80% by weight, and especially preferred to at least 90% by weight, of at least one polymer, which is water-soluble or which under alkaline conditions is converted into a water-soluble polymer.

The invention relates to new composite materials, which contain at least one thermoplastic organic polymer matrix and at least one hydraulic binder distributed in the polymer matrix. The invention also relates to a process for the preparation of such composite materials and their use in textile materials.

It is known in principle to increase the strength of hydraulic-setting compositions such as concrete, mortar, or even gypsum by the addition of fibers (cf. for example A. Neville (Ed.) ‘Fiber Reinforced Cement and Concrete’ Construction Press, Lancaster U.K. 1975; J. A. Manson ‘Modification of Concretes with Polymers’, Marter. Sci. Eng. 25 (1976), 41-52). Typical fibre materials for the reinforcement of hydraulic-setting compositions include steel fibres, polyolefin fibres such as polyethylene and polypropylene fibres, polyacrylonitrile fibres, aramid fibres, polyvinylalcohol fibres, glass fibres, boron fibres and carbon fibres, and suchlike. Such fibre materials, or textiles and yarns made therefrom, lead to reduced formation of shrink cracks in the hydraulic-setting compositions, improve their strength with respect to vibrations, and increase the compression strength, tensile strength, and bending strength of the hydraulic-setting compositions in the hardened state. However, the binding of the hydraulic-setting composition to the fibres or the textile material is incomplete. In the case of yarns, in particular multi-filament yarns, insufficient penetration of the filament material by the cement is observed, leading to local pull-out behaviour of the inner filaments. Thus, the obtained increase in strength is often unsatisfactory, and there is a risk that the hardened composition flakes off from the fibre material, or the textile made thereof, in particular when the fibre or textile material is located near to the surface of the hardened composition.

The problem underlying the present invention is to provide materials for improving the mechanical strength of hydraulic-setting compositions such as concrete or mortar, which overcome the disadvantages of the state of the art.

It was surprisingly found that this and further problems are solved by the novel composite materials described below, and by textile materials finished therewith, which, hereinafter are also referred to as textile materials of the invention.

The composite materials comprise at least one thermoplastic organic polymer matrix and at least one hydraulic binder distributed in the polymer matrix, where the thermoplastic polymer matrix consists predominantly, i.e. to at least 60% by weight, in particular to at least 70% by weight, preferably to at least 80% by weight, and especially preferred to at least 90% by weight, of at least one polymer, which is water-soluble or which under alkaline conditions is converted into a water-soluble polymer. Thus, a first aspect of the present invention relates to such composite materials.

Water-soluble polymers are understood to be polymers which at 20° C. have a water-solubility of at least 1 g/l. This solubility is preferentially given within a pH-range of 5 to 14, in particular in the range of 8 to 14. It has to be noted that the dissolution of polymers is usually rather slow. Therefore, solubility is given, if 1 g of polymer completely dissolves in 1 l of water at a given pH within 4 h.

A polymer which under alkaline conditions is converted into a water-soluble polymer is understood to be a polymer which at 20° C. has a water-solubility of at below 1 g/l but which upon contact at 20° C. with an alkaline material, in particular with an aqueous alkaline solution becomes soluble within 24 h. Soluble in water means a water-solubility of at least 1 g/l at 20° C. An aqueous alkaline solution means aqueous solution of a base, in particular of an alkali metal hydroxide, the aqueous solution having a pH of at least 10, preferably at least pH 12, more preferably pH 13. In particular, a polymer which under alkaline conditions is converted into a water-soluble polymer dissolves in a 1 N solution of an alkali metal hydroxide such as sodium hydroxide or potassium hydroxide within 24 h at 20° C.

A first embodiment of the invention relates to composite materials where the thermoplastic polymer matrix consists predominantly, i.e. to at least 60% by weight, in particular to at least 70% by weight, preferably to at least 80% by weight, and especially preferred to at least 90% by weight, of at least one polymer, which is water-soluble.

Examples for water-soluble polymers include
α) Homopolymers and copolymers of ethylenically unsaturated monomers, comprising at least one ethylenically unsaturated monomer a) in an amount of at least 30% by weight, based on the total weight of the homo- or copolymer, where the monomer a) has a water-solubility at 25° C. of at least 100 g/l;
β) Poly-C₂-C₄-alkylene glycols;
γ) Polyethyleneimine and polyvinylamine; as well as
δ) Polyvinylalcohols and partially hydrolyzed poly(vinylesters).

Homopolymers and copolymers α, which comprise at least one ethylenically unsaturated monomer a), include in particular homopolymers and copolymers, where the amount of the ethylenically unsaturated monomer a) is at least 40% by weight, in particular at least 60% by weight, and preferably at least 80% by weight of the homopolymers or copolymer. Especially preferred are homopolymers and copolymers, which are composed solely, i.e. to at least 95% by weight, of ethylenically unsaturated monomers a).

Examples of ethylenically unsaturated monomers a) include
monoethylenically unsaturated carboxylic acids having preferably 3 to 8 C-atoms, e.g. acrylic acid, methacrylic acid, itaconic acid, maleic acid, fumaric acid, vinylacetic acid, crotonic acid, etc.;
Hydroxyethyl and hydroxypropyl esters of the aforementioned monoethylenically unsaturated monocarboxylic acids such as hydroxylethyl acrylate, hydroxypropyl acrylate, hydroxyethyl methacrylate, and hydroxypropyl methacrylate;
Amides of the aforementioned monoethylenically unsaturated monocarboxylic acids such as acrylamide, methacrylamide, and maleimid;
N-Vinylamides, N-vinyllactames, and N-vinylaromatics such as N-vinylformamide, N-vinylacetamide, N-vinylpyrrolidone, and N-vinylimidazole.

The copolymers α can be copolymers which are solely composed of two or more different monomers a), or they can be copolymers which in addition to monomer a) also contain polymerized one or more ethylenically preferably monoethylenically unsaturated comonomers b) which are different from monomer a). Examples of such comonomers b) are vinylaromatic monomers such as styrene and alpha-methylstyrene, C₁-C₄-alkyl acrylates and C₁-C₄-alkyl methacrylates such as methyl acrylate, methyl methacrylate, ethyl acrylate, ethyl methacrylate, n-butyl acrylate and n-butyl methacrylate, also C₂-C₁₆-olefins such as ethylene, propene, 1-butene, 2-butane, isobutene, pentene, hexene, 1-octene or diisobutene; vinylesters of aliphatic C₁-C₁₀-carboxylic acids such as vinylformiate, vinylacetate, and vinylpropionate.

Examples of water-soluble homopolymers and copolymers a include polyacrylic acids, polyacrylamide, poly(hydroxyethylacrylate), poly(hydroxyethylmethacrylate), poly(vinylpyrrolidone), poly(vinylimidazole), copolymers of hydroxyethylacrylate and acrylic acid or methacrylic acid, copolymers of acrylic acid or maleic acid with styrene, copolymers of acrylic acid or maleic acid with diisobutene, copolymers of vinylpyrrolidone with vinylacetate or methylacrylate and others.

The water-soluble poly-C₂-C₄-alkyleneglycols β) are preferably polyethyleneglycols or copolymers having ethylene glycol and C₃-C₄-alkylene glycol units, in which the ethylene glycol units account for at least 50% by weight and in particular at least 70% by weight of the polymer.

Suitable water-soluble polymers γ) are also polyethyleneimines and polyvinylamines, including partially hydrolyzed polyvinylformamides and partially hydrolyzed polyvinylecetamides having a degree of hydrolysis of at least 30% and preferably of at least 50%.

Particularly suitable water-soluble polymers are the polyvinylalcohols and partially hydrolyzed poly(vinylesters) mentioned under δ), i.e. polyvinylalcohols obtained by partial hydrolysis of a poly(vinylester) of an aliphatic C₁-C₄-carboxylic acid, e.g. by hydrolysis of polyvinylformiate, polyvinylacetate or polyvinylpropionate. In the case of the partially hydrolyzed poly(vinylesters) the hydrolysates of polyvinylacetates are preferred. The degree of hydrolysis of the partially hydrolyzed poly(vinylesters) is preferably in the range of 40 to 80% and in particular in the range of 55 to 75%. The polyvinylalcohols and the partially hydrolyzed poly(vinylesters) can to a minor degree also have other monomer units, in particular such monomer units which are derived from ethylenically unsaturated monocarboxylic acids such as acrylic acid, methacrylic acid or itaconic acid. However, as a rule the proportion of these monomer units is not more than 10% by weight, based on the total weight of the polyvinylalcohol or the partially hydrolyzed poly(vinylester).

Preferred water-soluble polymers have a number-average molecular weight of at least 5000 Dalton, in particular at least 10000 Dalton, and more preferably of at least 20000 Dalton, e.g. in the range of 5000 to 500000 Dalton, in particular in the range of 10000 to 200000 Dalton, and more preferably in the range of 20000 to 150000 Dalton.

Since the polymer matrix is thermoplastic, the polymers forming the thermoplastic matrix melt or soften. The melting or softening range of the polymers that form the matrix does preferably not exceed 220° C., in particular not exceed 200° C. and more preferably not exceed 180° C. Preferably, the melting or softening range of the polymers that form the matrix is in the range of −50 to 220° C., in particular −40 to 200° C. and more preferably in the range of −30 to 180° C. Preferred water-soluble polymers have a melting or softening range in the range of 80 to 220° C., often in the range of 100 to 200° C., and in particular in the range of 120 to 180° C. However, water-soluble polymers may have also a melting or softening range below the above given limits, e.g. from −50 to 120° C., or −40 to 100° C. or −30 to 80° C. Preferred polymers which under alkaline conditions are converted into a water-soluble polymers have a melting or softening range in the range of −50 to 220° C., often in the range of −40 to 200° C., and in particular in the range of −30 to 180° C.

In a particularly preferred embodiment of the invention the water-soluble polymer is a partially hydrolyzed polyvinyl acetate having a degree of hydrolysis in the range of 60 to 70% and an average melting temperature in the range of 160 to 180° C.

A second embodiment of the invention relates to composite materials where the thermoplastic polymer matrix consists predominantly, i.e. to at least 60% by weight, in particular to at least 70% by weight, preferably to at least 80% by weight, and especially preferred to at least 90% by weight, of at least one polymer, which under alkaline conditions is converted into a water-soluble polymer.

Polymers which under alkaline conditions are converted into water-soluble polymers include those polymers, which have attached to the polymer backbone functional groups that are readily hydrolized into functional groups that impart increased water solubility without destructing the polymer backbone. Functional groups that are readily hydrolized include in particular:
C₁-C₄-alkoxycarbonyl groups that are hydrolyzed to the corresponding C₁-C₄-alkanol and to a carboxyl group attached to the polymer backbone;
formyloxy groups and C₁-C₉-alkylcarbonyloxy groups, in particular formyloxy groups, acetyloxy groups and propionyloxy groups that are hydrolyzed to the corresponding C₁-C₁₀-alkanoic acid and to a hydroxyl group attached to the polymer backbone.

Examples of polymers which under alkaline conditions are converted into water-soluble polymers include:
homopolymers and copolymers of C₁-C₄-alkylacrylates and C₁-C₄-alkylmethacrylates as monomer c), wherein the amount of monomer c) is at least 40% by weight, in particular at least 60% by weight, and preferably at least 80% by weight of the homopolymers or copolymer. Especially preferred are homopolymers and copolymers, which are composed solely, i.e. to at least 95% by weight, of monomers c). Besides the monomers c) these polymers may contain one or more polymerized monomers b) as mentioned above, which are different from C₁-C₄-alkylacrylates and C₁-C₄-alkylmethacrylates. The amount of monomers b) that are different from C₁-C₄-alkylacrylates and C₁-C₄-alkylmethacrylates will generally not exceed 60% by weight, in particular not more than 40% by weight, based on the total weight of the polymer. The polymers of this type may also contain polymerized up to 40% by weight, preferably not more than 10% by weight, based on the total weight of the polymer, of one or more monomer a) as mentioned above;
homopolymers and copolymers of vinylesters of C₁-C₁₀-alcanoic acids, in particular vinylesters of C₁-C₄-alcanoic acids such as vinylformiat, vinyl acetate or vinyl propionate as monomer d), wherein the amount of monomer d) is at least 15% by weight, in particular at least 30% by weight, and preferably at least 50% by weight of the homopolymers or copolymer. Besides the monomers d) these polymers may contain one or more polymerized monomers b) as mentioned above, which are different from vinylesters of C₁-C₁₀-alcanoic acids. The amount of monomers b) that are different from vinylesters of C₁-C₁₀-alcanoic acids, will generally not exceed 85% by weight, in particular 70% by weight and more preferably 50% by weight, based on the total weight of the polymer. The polymers may also contain polymerized monomers a) as mentioned above in an amount of not more than 40% by weight, preferably not more than 10% by weight, based on the total weight of the polymer. Especially preferred are homopolymers and copolymers, which are composed solely, i.e. to at least 95% by weight, of vinylesters of a C₁-C₁₀-alcanoic acids, in particular vinylesters of a C₁-C₄-alcanoic acid and more preferably vinylacetate. Likewise preferred are copolymers which contain from 15 to 95% by weight, based on the total weight of the polymer, in particular from 30 to 90% by weight and more preferably from 50 to 90% by weight of at least one vinylester of a C₁-C₁₀-alcanoic acids, in particular vinylester of a C₁-C₄-alcanoic acid and from 5 to 85% by weight, based on the total weight of the polymer, preferably from 10 to 70% by weight and more preferably from 50 to 90% by weight of at least one monomer b) as mentioned above that is different from the vinylesters of C₁-C₁₀-alcanoic acids. Amongst these, preference is given to those wherein the monomer b) is selected from the group of C₂-C₁₆-olefins, in particular from the group of C₂-C₄-olefins such as ethylene, propene, 1-butene, 2-butane or isobutene.

Preferred polymers which under alkaline conditions are converted into water-soluble polymers have a number-average molecular weight of at least 5000 Dalton, in particular at least 10000 Dalton, and more preferably of at least 20000 Dalton, e.g. in the range of 5000 to 2000000 Dalton, in particular in the range of 10000 to 1000000 Dalton, and more preferably in the range of 20000 to 500000 Dalton.

In a very preferred embodiment the polymer which under alkaline conditions is converted into a water-soluble polymer is selected from the group of
homopolymers and copolymers, which are composed solely, i.e. to at least 95% by weight, based on the total weight of the polymer, of vinylesters of a C₁-C₁₀-alcanoic acids, in particular vinylesters of a C₁-C₄-alcanoic acid and more preferably of vinylacetate;
copolymers which contain polymerized from 15 to 95% by weight, based on the total weight of the polymer, in particular from 30 to 90% by weight and more preferably from 50 to 90% by weight of at least one vinylester of a C₁-C₁₀-alcanoic acids, in particular vinylester of a C₁-C₄-alcanoic acid, more preferably vinylacetate, and from 5 to 85% by weight, based on the total weight of the polymer, preferably from 10 to 70% by weight and more preferably from 50 to 90% by weight of at least one monomer b) as mentioned above that is different from the vinylesters of C₁-C₁₀-alcanoic acids. Amongst these polymers preference is given to those wherein the monomer b) is selected from the group of C₂-C₁₆-olefins, in particular from the group of C₂-C₄-olefins such as ethylene, propene, 1-butene, 2-butane or isobutene.

As a rule, the water-soluble polymer or polymer which under alkaline conditions is converted into a water-soluble polymer accounts for 60 to 100% by weight, in particular 70 to 99.99% by weight, frequently 80 to 99.95% by weight, and especially 90 to 99.9% by weight, based on the total weight of the matrix.

The amount of the matrix in the composite material is typically in the range of 10 to 85% by weight and in particular in the range of 20 to 70% by weight, based on the total weight of the composite material. Accordingly, the amount of hydraulic binder is typically from 15 to 90% by weight, in particular from 30 to 80% by weight, based on the total weight of the composite material. The hydraulic binder may, however, be partially replaced by other filler components. However, the amount of such filler materials will usually not exceed 40% by weight and in particular 20% by weight, based on the total weight of the composite. Examples of such materials include dyes, pigments, inorganic fillers such as calcium carbonate, silicates, in particular layered silicates, silicic acid, alumina, titanium dioxide, fly ash or flue dust, respectively, as well as short fibres, which typically have a length of <15 mm, e.g. short fibres made of steel, organic polymers of carbon fibres.

According to the invention, the composite material contains at least one hydraulic binder. In the composite material the hydraulic binder is in non-hydrated form. Typical hydraulic binders include gypsum, including the semi-hydrate, anhydrite, and mixtures thereof, cement, e.g. Portland cement, alumina cement, or mixed cement such as Pozzolan-lime cement, also slag-lime cement or other types of cement. The hydraulic binder preferably contains cement, in particular Portland cement as the main component, i.e. in at least 60% by weight, in particular in at least 80% by weight, and preferentially in at least 90% by weight, based on the total weight of the hydraulic binder.

In the composite material the hydraulic binder typically has a particle size of below 1 mm and in particular below 500 μm. Preferred are those hydraulic binders, in particular cement-containing binders and especially Portland cement-containing binders, in which 10 to 85% by weight and in particular 60 to 85% by weight of the binder particles, based on the total weight of the hydraulic binders contained therein, have a particle size <200 μm, in particular <100 μm, preferentially <50 μm, and especially preferred of <25 μm.

In addition, the composite material may also contain additives such as softeners and/or superplastisizers. These components are apportioned to the matrix. As a rule, the amount of softeners will not exceed 10% by weight and in particular 5% by weight, based on the total weight of the composite material, and preferably is in a range of 0.05 to 5% by weight and in particular in the range of 0, 1 to 3% by weight, based on the total weight of the composite material. Examples of softeners include polyols having preferably 2 to 10 C-atoms such as glycol, glycerin, sorbitol, diethyleneglycol, triethyleneglycol or higher molecular polyethyleneglycols having a molecular weight of less than 1000 Dalton. The amount of superplastisizer will generally not exceed 10% by weight, based on the total weight of the composite material, and, if present, will typically be in the range of 0.01 to 5% by weight and in particular in the range of 0.02 to 3% by weight. Examples of superplastisizers include comb polymers having carboxylate groups and polyether side chains, e.g. copolymers of monoethylenically unsaturated carboxylic acids with monoethylenically unsaturated monomers having polyether groups, in particular copolymers of acrylic acid or methacrylic acid with alkylpolyethyleneglycol esters of these acids.

The composite materials of the present invention can be prepared by analogy to known processes for the preparation of composite materials of thermoplastic polymers and inorganic fillers of small particle size, as is described in the state of the art (cf. for example Ullmann's Encyclopedia of Industrial Chemistry, Composite Materials, 5th edition on CD-ROM, 1997, Wiley-VCH, Weinheim, Deutschland).

Generally, the preparation of the composite materials includes the mixing of at least one thermoplastic organic polymeric material, which mainly consists of the water-soluble polymers, with at least one particulate hydraulic binder at a temperature above the melting or softening point of the thermoplastic organic polymeric material and, if applicable, further additives such as softeners, superplastisizers, pigments, fillers, etc.

For the mixing process principally all devices that are commonly used for mixing inorganic materials into polymer melts, can be used. These include compounders, in particular single or multiple-screw compounders, as well as single or multiple-screw extruders, in particular counter-rotating double-screw extruders. Such devices and their setup are known to a skilled person, e.g. from F. Johannaber (Editor) Guide to Plastic Machinery, 3rd edition, C. Hanser Verlag, Munich 1992, pp. 278-401 (extruder) and p. 688 to 724 (mixers and compounders) [Kunststoffmaschinenführer, 3. Ausgabe, C. Hanser Verlag, München 1992, pp. 278-401 (Extruder) and p. 688 to 724 (Mischer und Kneter)].

Mixing is preferably performed at a temperature range of 80 to 220° C., in particular at a range of 90 to 200° C.

If required, an organic solvent is added during the mixing, which supports or affects a dissolution or softening of the water-soluble polymer. For mixing, solutions of the polymer in the organic solvent can also be used. The kind of suitable solvents depends on the water-soluble polymers being used in a known manner. Suitable organic solvents include for example alcohols such as ethanol, propanol, isopropanol, butanol, glycol, diethylene glycol, alkylethers of glycols and diglycols such as butylglycol and butyldiglycol, dialkylethers and cyclic ethers such as tetrahydrofurane, alkyl and cylcoalkylesters of aliphatic carboxylic acids such as ethylacetate, ethylpropionate, ethylbutyrate, butylacetate, etc. and mixtures thereof. Preferably, the solvent used is anhydrous. The organic solvent can be removed during or after the mixing, e.g. when the composite material is processed further.

When a solution of the polymer is mixed with the hydraulic binder, the usual mixing devices such as stirrers, compounders etc. can be used.

Mixing is generally performed until an even and homogeneous distribution of the hydraulic binder in the polymer matrix is achieved. An expert can determine the required mixing conditions by routine experiments.

After mixing a further processing step may follow, generally a thermal moulding, such as melt spinning, injection moulding, extrusion, laminating, rolling or pressing. Due to the thermoplastic matrix, the composite material can be made into any desired shape, which would be advantageous for the further use of the composite material. For example the composite material can be spun into fibres by melt spinning or made into moulded parts such as sticks, pellets, flakes, or granules by injection moulding or extruding. The composite materials of the present invention can also be processed into sheets by rolling or calendering, which can subsequently be laminated onto substrates. Shaped parts from the inventive composite materials can also be made by pressing fine particulate composite materials. For other applications it has been proven advantageous to process the composite material into a powder, which can then be used, for example, to cover the surface of woven materials or of yarns.

The composite materials according to the invention can be used in many different ways, e.g. as moulding materials, adhesives, compatibilisers, and in the refurbishment of buildings.

A preferred embodiment of the invention relates to the use of the composite materials of the invention for finishing textiles. Accordingly, the present invention relates to the finishing of textiles, in particular textiles based on inorganic fibres and especially based on glass fibres. The thus obtainable textile materials comprise a conventional textile material and a composite material according to the invention and are also subject of present invention.

According to the present invention, the term ‘textile’ or ‘textile material’ has to be understood according to the definition in DIN 60000, i.e. as a collective term for textile fibres, semi-finished and finished textile products as well as the finished goods made from these. Examples of suitable textiles are those based on aramid fibres, polyolefin fibres, polyacrylonitrile fibres, polyvinylalcohol fibres, boron fibres, glass fibres, carbon fibres and basalt fibres. In particular, the composites according to the present invention are suitable for finishing textile materials based on glass fibres. The preferred textile materials for finishing with the composites of the invention are short fibres, continuous filament yarns and semi-finished products such as woven material and non-wovens. Yarns which are finished according to the invention can also be processed into semi-finished products such as woven materials.

A preferred embodiment of the invention relates to finished yarns, in particular multi-filament hybrid yarns and composite yarns, as well as woven material made from these.

The preparation of the textile materials or material compositions according to the invention principally depends on the form or embodiment of the material. For the preparation of yarns, the composite materials of the invention can be spun into filaments, which can be processed with filaments of other, conventional fibres such as glass fibre filaments to multi-filament hybrid yarns. Furthermore, yarns or rovings, in particular glass rovings, can be soaked with the composite materials of the invention, in order to obtain composite yarns. In these composite yarns, the single filaments of the rovings are embedded into a matrix of the composite material of the invention and thus are separated from each other. The preparation of the composite yarns is preferentially achieved by solvent or melt pultrusion. For this the yarns or rovings are spread over one or more pins, while they can be fed through the molten thermoplastic filler composite or a suspension of the composite material in a non-aqueous, organic solvent. The yarns which are equipped in this way can be further processed to woven material, either on their own or in a mixture with conventional yarns.

In a further embodiment of the invention, a semi-finished product such as a woven material or a non-woven is finished with the composite material of the present invention. For this, the composite material of the invention is distributed in the form of fine particles, e.g. in the form of a powder, on the semi-finished product and is pressed onto it by applying increased temperature and pressure, preferably at a temperature above the melting point of the polymeric matrix material. Alternatively, the semi-finished product can be soaked in a suspension of the composite material in a non-aqueous organic solvent and the organic solvent is subsequently removed.

According to a preferred embodiment of the invention, a yarn, in particular a multi-filament fibre, e.g. a glass fibre roving is equipped with a composite material of the invention. For this, the yarn can be treated with a suspension of at least one hydraulic binder in a solution of at least thermoplastic, organic polymeric material, which mainly consists of water-soluble polymers, in an organic solvent according to the method of solvent pultrusion, where the organic solvent is removed at the same time. In a similar manner, a yarn can be finished with the composite material of the invention by the method of melt pultrusion. In both cases, a material in the form of a yarn is obtained, which is finished with the composite material of the invention, thereby achieving a good penetration of the yarn with the composite material.

The ratio of inventive composite material to textile material may vary over a wide range and typically lies in the range of 10 to 70° by weight or in particular in the range of 20 to 60% by weight, based on the total weight of the composite material and the textile material.

The textile materials obtained in this way are particularly suitable for finishing hydraulic-setting compositions, in particular for the reinforcement of mixtures such as concrete or mortar which are bound together by cement.

The textile material of the present invention can be used for the reinforcement of the hydraulic-setting material, either in the shape of short fibres, of yarns, or of woven material made from these. Conventional semi-finished products, which are finished with the composite materials of the invention, can also be used for the reinforcement of hydraulic-setting material. The textile materials of the invention are particularly suitable for reinforcing mixtures such as concrete or mortar which are bound together by cement.

Without being bound to a theory, it is presumed that upon contact of the textile material of the invention with the damp, non-bound hydraulic-setting material, the matrix material swells and that, thereby, the individual filaments of the textile material are pressed apart. Subsequently, the matrix is probably dissolved, whereby the now exposed hydraulic binder is bound to the surrounding media. In this way, the whole cross-section of the yarn or fibre is evenly bound to the surrounding matrix. This leads to a significant increase in the force which the reinforcement can absorb and to better stability against cracks.

The following examples demonstrate the invention.

An injection binder that was rich in Portland cement clinker and which had a particle size distribution d₉₅≦7 μm (Mikrodur® P-X from Dyckerhoff) was used as cement.

The polyvinylalcohol which was used was a partially hydrolysed poly(vinylacetate) from Wacker, with a degree of hydrolysis in the range of 60 to 70% and an average melting range of 160-180° C.

The poly(ethylene-co-vinylacetate) had a vinylacetate content of about 40% by weight and a molecular weight of about 110000 Dalton (110 kDa) and was obtained from Acros Chemicals.

Polyvinylacetates having a molecular weight of 55-70 kDa (PVA1), 110-150 kDa (PVA2) or 330-430 kDa (PVA3), respectively, were obtained from Carl Roth GmbH & CoKG, Karlsruhe (PVA1) or from Wacker, Burghausen (PVA2, PVA3).

The superplastisizer which was used was an aqueous solution of polycarboxylate ether (30%), which is commercially available under the tradename MVA 2500 from Degussa Bauchemie GmbH/Trostberg.

### PREPARATION EXAMPLE 1

8 g of polyvinylalcohol were mixed with 1 ml of a 30% aqueous solution of a PCE superplastisizer and 0.8 ml glycerine in a lab-scale extruder at 150° C. to evaporate the water. 10 g of cement were added to the melt while continuously kneading. The cement content of the material obtained in this way was approx. 52% by weight. The obtained composite material was extruded to form a rope having a diameter of 2 mm.

### PREPARATION EXAMPLE 2

3 g of polyvinylalcohol were dissolved in 3 ml of a 30% by weight aqueous solution of a PCE superplastisizer. The mixture was subsequently freeze dried. 3 g of this mixture was mixed with 7 g of cement in an extruder and the mixture was extruded to give a rope having a diameter of 2 mm. The cement content was approx. 70% by weight.

### PREPARATION EXAMPLE 3

3 g of polyvinylalcohol and 7 g of cement were mixed in an extruder at 150° C. and extruded to give a rope having a diameter of 2 mm. The cement content was approx. 70% by weight.

### PREPARATION EXAMPLE 4

In an extruder, 12 g of cement and 0.8 ml of polyethyleneglycol (molecular weight 400 Dalton) were added to 3 g of polyvinylalcohol at 150° C. and the mixture was then extruded to give a rope having a diameter of 2 mm. The cement content was approx. 75% by weight.

### PREPARATION EXAMPLE 5

4 g of polyvinylalcohol were dissolved in 60 ml of anhydrous ethanol or anhydrous tetrahydrofurane in an ultra-sonification bath. Subsequently, 16 g of cement were added with strong stirring. The thus obtained material contained approx. 80% by weight of cement and remained plyable for several hours. After this, brief stirring with a small amount of solvent was necessary before further use.

### PREPARATION EXAMPLE 6

8 g of poly(ethylene-co-vinylacetate) were dissolved in 60 ml of anhydrous tetrahydrofurane. Subsequently, 32 g of cement were added with strong stirring. The thus obtained material contained approx. 80% by weight of cement, based on the total amount of cement and polymer.

### PREPARATION EXAMPLE 7

10 g of polyvinylacetate PVA1 were dissolved in 50 ml of anhydrous ethyl acetate. Subsequently, 40 g of cement were added with strong stirring. The thus obtained material contained approx. 80% by weight of cement, based on the total amount of cement and polymer.

### PREPARATION EXAMPLES 8 AND 9

The preparation examples were performed by analogy to preparation example 7, but using PVA2 or PVA3 instead.

### PROCESSING EXAMPLE 1

3.5 g of a composite material prepared according to preparation example 1 were molten at 160° C. and formed by injection moulding to give a plate of 2×12×60 mm in size.

### PROCESSING EXAMPLE 2

2 g of a composite material prepared according to preparation example 1 were crushed and strewn across an AR glass roving. This conglomerate was pressed under light pressure to a band 0.2 mm in thickness.

### PROCESSING EXAMPLES 3 TO 6

The composite materials from preparation examples 2 to 4 were shaped by analogy to processing example 1 to give plates of 2×12×60 mm in size.

### PROCESSING EXAMPLES 7 TO 9

The composite materials from preparation examples 2 to 4 were crushed and pressed to bands of 0.2 mm in thickness by analogy to processing example 2.

### PROCESSING EXAMPLES 10 TO 14

The composite materials from preparation examples 5 to 9 were transferred to a pultrusion apparatus and used for the continuous coating of AR glass rovings.

| | Composite/ | |
|---|---|---|
| Processing Example | Preparation Ex. | Matrix Polymer |
| 10 | 5 | polyvinylalcohol |
| 11 | 6 | poly(ethylene-co-vinylacetate) |
| 12 | 7 | Polyvinylacetate PV1 |
| 13 | 8 | Polyvinylacetate PV2 |
| 14 | 0 | Polyvinylacetate PV3 |

### APPLICATION EXAMPLE 1

A band prepared according to processing example 1 was placed into a fresh concrete mixture PZ-0502-01-DWI-ST (w/c=0.2 (water to cement ratio)) and hardened under water for 48 h. After this time the obtained specimen was cut in the middle and the distribution of the individual filaments investigated under the microscope. This proved that the roving was completely soaked with the cement and embedded in it.

### APPLICATION EXAMPLE 2

An untreated AR glass roving was placed into a concrete mixture as described in application example 1 and investigated after hardening. This showed that the roving was not soaked with the cement and that only the outer filaments were in contact with the cement.

### APPLICATION EXAMPLE 3

A impregnated roving prepared according to processing example 10 was cut into eight pieces of 230 mm in length and tested in a double-sided pull-out experiment as described by M. Raupach, J. Brockmann, ‘Development of a Test Method to Investigate the Durability of Glass-Filament-Yarns Embedded in Concrete’, Proceedings of the International Conference on Composites in Constructions, Porto, Portugal, 2001, pp. 293-297. The maximum strain at complete debonding was found to be 645 N/mm², followed by slip hardening during pull-out.

### APPLICATION EXAMPLE 4

By analogy to application example 3 the treated AR glass roving of processing example 11 was tested in a double-sided pull-out experiment. Here the maximum strain at complete debonding was found to be about 734 N/mm². Pullout after debonding occurred at high strain.

### APPLICATION EXAMPLE 5

By analogy to application example 3 the treated AR glass roving of processing example 12 was tested in a double-sided pull-out experiment. Here the maximum strain at complete debonding was found to be about 1208 N/mm². The strength of the composite exceeded the strength of the glass rovings.

Similar behaviour and similar maximum strain (within ±150 N/mm²) was found for processing examples 13 and 14 when tested according to application example 3.

### APPLICATION EXAMPLE 6

### Comparative

By analogy to application example 3 an untreated AR glass roving was tested in a double-sided pull-out experiment. Here the maximum strain at complete debonding was found to be about 200 N/mm² followed by brittle behaviour.

1. Composite material comprising at least one thermoplastic organic polymer matrix and at least one hydraulic binder, which is distributed in the polymer matrix, where the thermoplastic polymer matrix predominantly consists of at least one polymer, which is water-soluble or which under alkaline conditions is converted into a water-soluble polymer.

2. The composite material according to claim 1, where the amount of hydraulic binder is from 15 to 90% by weight of the composite material.

3. The composite material according to claim 1, where the hydraulic binder contains cement as main component.

4. The composite material according to claim 1, where the hydraulic binder has a particle size below 1 mm.

5. The composite material according to claim 1, where the polymer in the matrix has a melting or softening point in the range of −50 to 220° C.

6. The composite material according to claim 1, where the polymer matrix predominantly consists of at least one water-soluble polymer.

7. The composite material according to claim 6, where the water-soluble polymer is selected from:
Homopolymers and copolymers of ethylenically unsaturated monomers a) having a water-solubility of at least 100 g/l at 25° C., and where the amount of monomer a) in the copolymers of monomers a) is at least 30% by weight of the copolymer;
Poly-C₂-C₄-alkylene glycols,
Polyethyleneimines,
Polyvinyl alcohols and partially hydrolysed poly(vinylesters).

8. The composite material according to claim 7, where the water-soluble polymer is a partially hydrolysed poly(vinylester) having a degree of hydrolysis in the range of 40 to 80%.

9. The composite material according to claim 1, where the polymer matrix predominantly consists of at least one polymer, which under alkaline conditions is converted into a water-soluble polymer.

10. The composite material according to claim 6, where the polymer which under alkaline conditions becomes water-soluble is a homopolymer or copolymer of a vinylester of a C₁-C₁₀ alkanoic acid, wherein the amount of polymerized vinylester of the C₁-C₁₀ alkanoic acid is at least 15% by weight, based on the total weight of the polymer.

11. The composite material according to claim 1, where the amount of thermoplastic organic polymer matrix is from 10 to 85% by weight of the composite material.

12. The composite material according to claim 1, additionally comprising at least one softener and/or one super-plasticizer.

13. A process for the preparation of a composite material according to claim 1, which comprises mixing of at least one thermoplastic organic polymeric material, consisting predominantly of at least one polymer, which is water-soluble or which under alkaline conditions is converted into a water-soluble polymer, with at least one particulate hydraulic binder at a temperature above the melting or softening point of the thermoplastic organic polymeric material.

14. The process according to claim 13, additionally comprising further processing of the material obtained after the mixing step by thermal moulding.

15. A process for the preparation of a composite material according to claim 1, which comprises mixing of a solution of at least one thermoplastic organic polymeric material, which predominantly consists of at least one polymer, which is water-soluble or which under alkaline conditions is converted into a water-soluble polymer, in an organic solvent with at least one particulate hydraulic binder and removal of the organic solvent.

16. (canceled)

17. (canceled)

18. A textile material, comprising a conventional textile material and a composite material according to claim 1.

19. The material according to claim 18, where the textile material is made of glass fibres.

20. The material according to claim 18 in the form of a multi-filament hybrid yarn or a composite yarn or a semi-finished product made thereof.

21. A process for the preparation of a material according to claim 18, which comprises finishing a textile material with a composite material according to claim 1.

22. The process according to claim 21, where a suspension of at least one hydraulic binder in a solution of an at least thermoplastic organic polymeric material consisting predominantly of at least one polymer, which is water-soluble or which under alkaline conditions is converted into a water-soluble polymer, is applied to a yarn in an organic solvent by solution pultrusion, where the organic solvent is removed, or the application of a melt of the composite material onto a yarn by melt pultrusion.

23. (canceled)

24. A method for reinforcing concrete or mortar comprising combining the concrete or mortar with a composite material of claim 1.
